(19) United States
(12) Patent Application Publication
(10) Pub. No.: US 2024/0314774 A1
(43) Pub. Date: Sep. 19, 2024

(54) METHOD AND APPARATUS FOR UPLINK TRANSMISSION

(71) Applicant: Lenovo (Beijing) Limited, Beijing (CN)

(72) Inventors: Wei Ling, Beijing (CN); Chenxi Zhu, Fairfax, VA (US); Bingchao Liu, Beijing (CN); Yi Zhang, Beijing (CN); Lingling Xiao, Beijing (CN)

(73) Assignee: Lenovo (Beijing) Limited, Beijing (CN)

(21) Appl. No.: 18/576,542

(22) PCT Filed: Jul. 15, 2021
(86) PCT No.: PCT/CN2021/106466

§ 371 Date: Jan. 4, 2024

(51) Int. Cl. H04W 72/1268; H04L 5/00

(52) U.S. Cl. CPC H04W 72/1268; H04L 5/0091

(57) ABSTRACT

Embodiments of the present application are related to a method and apparatus for uplink transmission. An exemplary method of the present application includes: receiving information indicating a plurality of joint or UL common TCI states; receiving a beam indication indicating at least one joint or UL common TCI state of the plurality of joint or UL common TCI states to be used for an uplink transmission, wherein a repetition number of the uplink transmission is equal to or larger than one; and transmitting the uplink transmission, wherein: in the case that the beam indication indicates only one joint or UL common TCI state, transmitting the uplink transmission according to the beam indication; or in the case that the beam indication indicates more than one joint or UL common TCI state, transmitting the uplink transmission according to the beam indication and a beam mapping pattern configured for the uplink transmission.

### TECHNICAL FIELD

Embodiments of the present application generally relate to wireless communication technology, especially to a method and an apparatus for uplink transmission.

### BACKGROUND

Regarding enhancements on multiple-input multiple-output (MIMO) for new radio (NR), a work item description (WID) approved in NR R17 includes enhancement on multi-beam operation, mainly targeting frequency range (FR)2 while also applicable to FR1. Wherein, a research topic is to identify and specify features to facilitate more efficient (lower latency and overhead) downlink/uplink (DL/UL) beam management to support higher intra-band and L1/L2-centric inter-cell mobility and/or a larger number of configured transmission configuration indication (TCI) states, including common beam for data and control transmission/reception for DL and UL, especially for intra-band carrier aggregation (CA).

In addition, it has been agreed that downlink control information (DCI) format 1_1 and DCI format 1_2 can be used for DL and UL joint common beam indication, and it has been proposed that DCI format 1_1 and DCI format 1_2 can be used for UL only common beam indication in RAN1 #103e. Moreover, more than one joint or UL common beam indicated by DCI in a physical downlink control channel (PDCCH) is also under discussion especially for the case of multiple transmit-receive points (TRP)s. For a UL resource in a scenario of multiple TRPs, e.g., two TRPs, in the case that the UL resource is configured with multiple repetitions while a user equipment (UE) is not capable to transmit UL resources with multiple beams simultaneously, the UL resource can be transmitted to any of the two TRPs or both of the two TRPs in a time division multiplexing (TDM) manner.

However, the PUSCH repetition enhancement and PUCCH repetition enhancement in R17 are based on R15 and/or R16, wherein the beam(s) of a PUSCH resource is indicated by its associated sounding reference signal (SRS) resource(s) and the beam(s) of a PUCCH resource is activated by a medium access control (MAC) control element (CE). Apparently, these cannot be applied to the common beam mode in R17 as stated above, because the beam(s) of any UL resource in the common beam mode is determined as a joint or UL common beam indicated by DCI in a PDCCH, which is different from the solutions specified in R15 and R16.

Therefore, when multiple joint or UL common beams are indicated, e.g., for multi-TRP transmission, how to determine the transmission beam of a UL transmission should be studied and determined.

### SUMMARY OF THE APPLICATION

One objective of the embodiments of the present application is to provide a technical solution for UL transmission, e.g., determination of joint or UL common beam(s) for UL transmission.

According to an embodiment of the present application, a method may include: receiving information indicating a plurality of joint or UL common TCI states; receiving a beam indication indicating at least one joint or UL common TCI state of the plurality of joint or UL common TCI states to be used for an uplink transmission, wherein a repetition number of the uplink transmission is equal to or larger than one; and transmitting the uplink transmission, wherein: in the case that the beam indication indicates only one joint or UL common TCI state, transmitting the uplink transmission according to the beam indication; or in the case that the beam indication indicates more than one joint or UL common TCI state, transmitting the uplink transmission according to the beam indication and a beam mapping pattern configured for the uplink transmission.

According to another embodiment of the present application, a method may include: transmitting information indicating a plurality of joint or UL common TCI states; transmitting a beam indication indicating at least one joint or UL common TCI state of the plurality of joint or UL common TCI states to be used for an uplink transmission, wherein a repetition number of the uplink transmission is equal to or larger than one; and receiving the uplink transmission, wherein: in the case that the beam indication indicates only one joint or UL common TCI state, receiving the uplink transmission according to the beam indication; or in the case that the beam indication indicates more than one joint or UL common TCI state, receiving the uplink transmission according to the beam indication and a beam mapping pattern configured for the uplink transmission.

In some embodiments of the present application, in the case that the uplink transmission is a configured grant Type 1 PUSCH transmission or is a PUCCH transmission, the beam indication is transmitted and received in a radio resource control (RRC) signaling for configuring the uplink transmission.

In some other embodiments of the present application, in the case that the uplink transmission is a PUSCH transmission scheduled or activated by DCI in a PDCCH, the beam indication is transmitted and received in the DCI.

In some yet other embodiments of the present application, in the case that the uplink transmission is a PUCCH transmission, the beam indication is transmitted and received in a MAC CE associated with the PUCCH transmission.

In some yet other embodiments of the present application, a first state of the beam indication indicates that all repetition(s) of the uplink transmission is transmitted according to a first joint or UL common TCI state of the plurality of joint or UL common TCI states, and a second state of the beam indication indicates that all the repetition(s) of the uplink transmission is transmitted according to a second joint or UL common TCI state of the plurality of joint or UL common TCI states.

In some yet other embodiments of the present application, in the case that the repetition number of the uplink transmission is larger than one, a third state of the beam indication indicates that all the repetitions of the uplink transmission are transmitted according to the plurality of joint or UL common TCI states where a first repetition of the uplink transmission is transmitted according to a first joint or UL common TCI state of the plurality of joint or UL common TCI states.

In some yet other embodiments of the present application, in the case that the repetition number of the uplink transmission is larger than one, a fourth state of the beam indication indicates that all the repetitions of the uplink transmission are transmitted according to the plurality of joint or UL common TCI states where a first repetition of the uplink transmission is transmitted according to a second joint or UL common TCI state of the plurality of joint or UL common TCI states.

Some embodiments of the present application also provide an apparatus, including: at least one non-transitory computer-readable medium having computer executable instructions stored therein, at least one receiving circuitry; at least one transmitting circuitry; and at least one processor coupled to the at least one non-transitory computer-readable medium, the at least one receiving circuitry and the at least one transmitting circuitry. The computer executable instructions are programmed to implement a method according to any embodiment of the present application with the at least one receiving circuitry, the at least one transmitting circuitry and the at least one processor.

Embodiments of the present application provide a technical solution for uplink transmission, especially for beam determination for uplink transmission in case of multi joint or UL common beams being configured, and thus can facilitate and improve the implementation of 5G NR.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to an embodiment of the present application;

FIG. 2 is a flow chart illustrating a method for uplink transmission according to some embodiments of the present application;

FIG. 3 illustrates a schematic diagram of beam determination for uplink transmission in the case of two joint or UL common beams being indicated to a UE according to some embodiments of the present application; and

FIG. 4 illustrates a block diagram of an apparatus for uplink transmission according to some embodiments of the present application.

### DETAILED DESCRIPTION

The detailed description of the appended drawings is intended as a description of preferred embodiments of the present application, and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP long term evolution (LTE) R8 and so on. Persons skilled in the art know very well that, with the development of network architecture and new service scenarios, the embodiments in the present application are also applicable to similar technical problems.

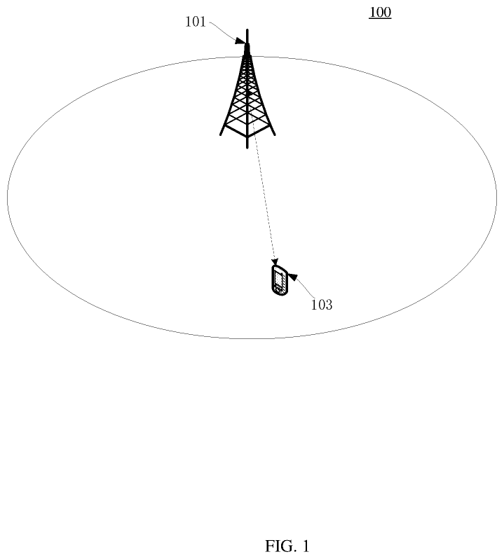

FIG. 1 illustrates a schematic diagram of an exemplary wireless communication system 100 according to some embodiments of the present application.

As shown in FIG. 1, the wireless communication system 100 includes a UE 103 and a BS 101. Although merely one BS is illustrated in FIG. 1 for simplicity, it is contemplated that the wireless communication system 100 may include more BSs in some other embodiments of the present application. Similarly, although merely one UE is illustrated in FIG. 1 for simplicity, it is contemplated that the wireless communication system 100 may include more UEs in some other embodiments of the present application.

The BS 101 may be distributed over a geographic region, and generally be a part of a radio access network (RAN) that may include one or more controllers communicably coupled to one or more corresponding BSs 101. In some embodiments of the present application, the BS 101 may also be referred to as an access point, an access terminal, a base, a macro cell, a Node-B, an evolved Node B (eNB), a TRP, a gNB, a Home Node-B, a relay node, a device, or described using other terminology used in the art.

The UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 103 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 103 may include wearable devices, such as smart watches, fitness bands, optical head-mounted displays, or the like. Moreover, the UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art. Different UEs 103 may be with the same device type or different device types.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

According to NR R17, multiple beams, e.g., two beams can be indicated or configured for uplink transmission with repetition, e.g., PUSCH transmission with repetition or PUCCH transmission with repetition, wherein each beam is associated with at least one repetition according a configured beam mapping pattern. Herein (throughout the specification), the terminology “beam” can be represented by “TCI state” or “spatial relation information” etc. However, a UE may not have the capability to transmit a UL transmission with two or more beams simultaneously considering the power limitation of UEs.

In addition, regarding PUSCH transmission (or PUSCH resource), according to R17, there are two SRS resource sets configured for PUSCH transmission and a new field for indicating with which SRS resource set each repetition of a PUSCH transmission is associated, wherein a UE cannot transmit UL transmission with two beams simultaneously. Meanwhile, a joint or UL common beam is used to indicate the UL transmit filter of any PUSCH transmission in R17. However, there is even no study and discussion on how to apply the common beam scheme in the PUSCH repetition enhancement for multiple TRPs in R17.

Regarding PUCCH transmission (or PUCCH resource), according to R17, a MAC CE can activate two beams or power control parameter sets for a PUCCH with repetition transmitted to multiple TRPs. Meanwhile, for a PUCCH transmission activated by a MAC CE with only one beam, it is transmitted to a single TRP. Therefore, the beam(s) activated by a MAC CE for a PUCCH transmission can indicate to which TRP(s) the PUCCH transmission will be transmitted. However, based on the agreements on the common beam indication in R17, joint common beam(s) or UL common beam(s) is indicated by DCI in a PDCCH for all PUSCH transmissions and all or subset of PUCCH transmissions. There is no MAC CE for a PUCCH transmission any more to indicate to which TRP the PUCCH transmission is transmitted in the common beam mode.

Therefore, when multiple joint or UL common beams are indicated, how to determine the beam of each repetition of an uplink transmission should be clarified and specified.

At least for solving the above technical problem, embodiments of the present application provide a technical solution for uplink transmission, especially for determination of common beam(s) for uplink transmission, e.g., in a multi-TRP or multi-panel scenario.

According to some embodiments of the present application, a plurality of beams are indicated or determined according to a predefined rule to a UE for uplink transmission, e.g., considering a scenario of multi-TRP or multi-panel. In a common beam mode, the plurality of beams are more than one joint or UL common beam.

An uplink transmission can also be referred to as an uplink resource, which may be a PUSCH transmission or a PUCCH transmission. In the case that the number of repetition is defined to be larger than one, an uplink transmission can be an uplink transmission without repetition or an uplink transmission with repetition. An uplink transmission occasion, e.g., a PUSCH or PUCCH transmission occasion is a repetition of an uplink transmission with repetition, or an uplink transmission without repetition. While, in the case that the number of repetition is defined to be equal to or larger than one, any uplink transmission can be called as an uplink transmission with repetition, including an uplink transmission that is only transmitted once. In such a case, an uplink transmission occasion, e.g., a PUSCH or PUCCH transmission occasion is a repetition of a PUSCH or PUCCH transmission. In any of the above case, the repetition number of an uplink transmission can be indicated by scheduling or activation DCI, or configured by a RRC signaling.

For example, when an uplink transmission is a PUSCH transmission, it may be a PUSCH transmission with or without repetition, e.g., being a PUSCH repetition type A or a PUSCH repetition type B. Different from PUSCH repetition type A, in PUSCH repetition type B, concepts “nominal repetition” and “actual repetition” are introduced so that multiple repetitions within one slot will be identified, which can refer to TS 38.214. PUSCH repetition Type A and PUSCH repetition Type B can be dynamically indicated with different repetition numbers, wherein the repetition number can even be one. In addition, for a PUCCH transmission, the repetition number can be RRC configured per PUCCH format. Herein, for simplification, if no otherwise specified, the uplink transmission means an uplink transmission with repetition, wherein the repetition number is equal or larger than one.

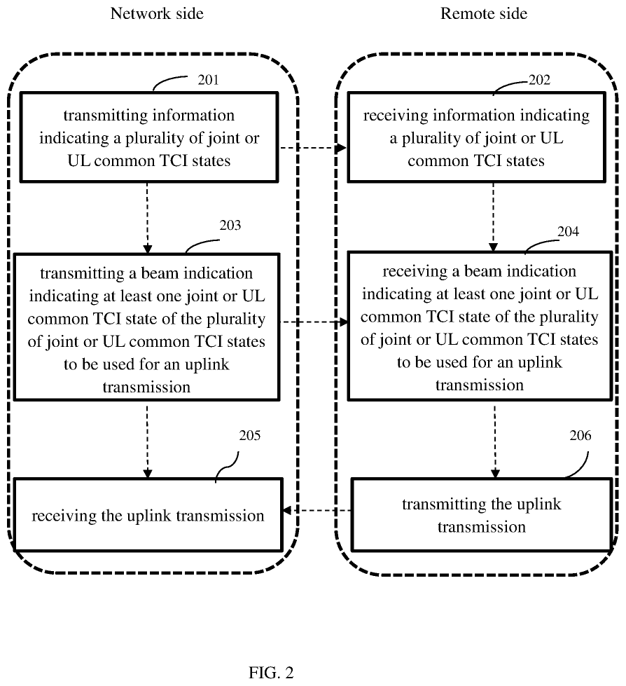

FIG. 2 illustrates a flow chart of a method for uplink transmission according to some embodiments of the present application. Although the method is illustrated in a system level by a UE in a remote side (or UE side) and a BS in a network side (or BS side), persons skilled in the art can understand that the method implemented in the remote side and that implemented in the network side can be separately implemented and incorporated by other apparatus with similar functions. In addition, no transmission or reception failure is considered in the illustrated embodiments of the present application.

In the exemplary method shown in FIG. 2, in step 201, the network side, e.g., a BS 101 in FIG. 1 will transmit information indicating a plurality of joint or UL common beams to the remote side, e.g., to a UE 103 as shown in FIG. 1. In some embodiments of the present application, the information indicating a plurality of joint or UL common beams indicates a plurality of joint or UL common TCI states via DCI in a PDCCH, each joint or UL common TCI state on behalf of a joint or UL common beam. The plurality of joint or UL common TCI states may be two or more joint or UL common TCI states. Accordingly, in the remote side, in step 202, the UE will receive the information indicating a plurality of joint or UL common beams, e.g., receiving the information indicating a plurality of joint or UL common TCI states.

However, as stated above, the UE does not have the capability to transmit more than one beam simultaneously. That is, only one of the plurality of joint or UL common beams can be used to transmit an uplink transmission occasion. Thus, for an uplink transmission to be transmitted, the UE needs to know which joint or UL common beam(s) should be used.

According to some embodiments of the present application, a beam indication is used to specifically indicate with which beam(s) an uplink transmission is transmitted. As shown in FIG. 2, in step 203, the network side, e.g., the BS 101 as shown in FIG. 1 will transmit a beam indication to the remote side, indicating at least one joint or UL common beam of the plurality of joint or UL common beams to be used for an uplink transmission. For example, a beam indication indicating at least one joint or UL common TCI state of the indicated plurality of joint or UL common TCI states will be transmitted to the remote side. Accordingly, in step 204, the remote side, e.g., the UE 103 as shown in FIG. 1 will receive the beam indication.

For example, in the case that the uplink transmission is a configured grant Type 1 PUSCH transmission or is a PUCCH transmission, the beam indication will be transmitted from the network side and received in the remote side in a RRC signaling for configuring the uplink transmission. In some other embodiments of the present application, in the case that the uplink transmission is a PUSCH transmission scheduled or activated by DCI in a PDCCH, the beam indication will be transmitted from the network side and received in the remote side in the DCI. In some yet other embodiments of the present application, in the case that the uplink transmission is a PUCCH transmission, the beam indication will be transmitted from the network side and received in the remote side in a MAC CE associated with the PUCCH transmission.

According to some embodiments of the present application, for an uplink transmission with only one repetition, one joint or UL common beam of the plurality of joint or UL common beams is determined according to the beam indication. That is, for an uplink transmission with only one repetition, the beam indication will indicate only one joint or UL common beam. For an uplink transmission with more than one repetition, in the case that only one beam is applied for the uplink transmission according to the beam indication, the beam for each repetition is determined only according to the beam indication; while in the case that multiple beams, e.g., two beams are applied for the uplink transmission according to the beam indication, the beam for each repetition will be determined according to the beam indication together with a beam mapping pattern. Accordingly, the beam mapping pattern, e.g., a cyclical mapping pattern or a sequential mapping pattern as agreed by 3GPP, will also be indicated to the remote side. That is, for an uplink transmission with more than one repetition, in some embodiments of the present application, the beam indication may indicate only one joint or UL common beam of the plurality of joint or UL common beams, and each repetition of the uplink transmission will be transmitted by the only one joint or UL common beam indicated by the beam indication. In some other embodiments of the present application, the beam indication may indicate more than one joint or UL common beam for an uplink transmission with more than repetition, which may be part or all of the plurality of joint or UL common beams. In the case that the beam indication indicates multiple beams for an uplink transmission with more than one repetition, each repetition of the uplink transmission will be transmitted according the beam indication and the beam mapping pattern.

For example, the network side may configure two joint or UL common beams, e.g., beam #1 and beam #2 by transmitting DCI in a PDCCH indicating two TCI states, e.g., TCI state #1 on behalf of beams #1, and TCI state #2 on behalf of beam #2. For an uplink transmission with more than one repetition to be transmitted, a beam indication indicates that both the two beams will be used to transmit the uplink transmission with more than one repetition, wherein the first beam will be used to transmit the first repetition of the uplink transmission. In addition, a beam mapping pattern will be received, so that each repetition of the uplink transmission is associated with a corresponding beam of the two beams based on the beam mapping pattern. The beam mapping pattern can be any beam mapping pattern, e.g., a cyclical mapping pattern, or a sequential mapping pattern. For example, when the cyclical mapping pattern is enabled, the first and second beams (or TCI states) are applied to the first and second transmit units, respectively, and the same mapping pattern continues to the remaining transmit units. Accordingly, the cyclical mapping pattern might be #1 #2 #1 #2 #1 #2 #1 #2 . . . . When the sequential mapping pattern is enabled, the first beam is applied to the first and second transmit units, and the second beam is applied to the third and fourth transmit units, and the same beam mapping pattern continues to the remaining transmit units. Accordingly, the sequential mapping pattern might be #1 #1 #2 #2 #1 #1 #2 #2 . . . .

According to some embodiments of the present application, the beam indication can be defined to have a plurality of states. Except for the reserved state(s) (if any), each state indicates which beam(s) will be used for transmitting an uplink transmission. For example, in the case that the information indicating a plurality of joint or UL common indicates two joint or UL common beams, at least three states can be defined for the beam indication to indicate one or more beams for the uplink transmission. In some embodiments of the present application, a first state of the beam indication indicates that all repetition(s) of the uplink transmission is transmitted according to the first joint or UL common TCI state of the plurality of joint or UL common TCI states; a second state of the beam indication indicates that all the repetition(s) of the uplink transmission is transmitted according to the second joint or UL common TCI state of the plurality of joint or UL common TCI states; a third state of the beam indication indicates that in the case that the repetition number of the uplink transmission is larger than one, all the repetitions of the uplink transmission are transmitted according to the plurality of joint or UL common TCI states wherein the first repetition of the uplink transmission is transmitted according to the first joint or UL common TCI state of the plurality of joint or UL common TCI states. In some other embodiments of the present application, the third state of the beam indication may indicate that in the case that the repetition number of the uplink transmission is larger than one, all the repetitions of the uplink transmission are transmitted according to the plurality of joint or UL common TCI states, wherein the first repetition of the uplink transmission is transmitted according to the second joint or UL common TCI state of the plurality of joint or UL common TCI states. However, in some other embodiments of the present application, four states of the beam indication can be defined, and the later exemplary third state, i.e., indicating that an uplink transmission is transmitted with the plurality of joint or UL common TCI states, wherein the first repetition of the uplink transmission is transmitted with the second joint or UL common TCI state of the plurality of joint or UL common TCI states, is defined as the fourth state.

According to some embodiments of the present application, in the case that the information indicating two joint or UL common beams to the remote side, two bits can be used to indicate a state of the beam indication, for example, “00” can be used to indicate the first state, “01” can be used to indicate the second state, “10” can be used to indicate the third state, and “11” can be used to indicate the fourth state if any or can be reserved if only three states are substantially defined.

Persons skilled in the art should understand that the above exemplary embodiments for defining and indicating the states of a beam indication are only for illustrating the concept and principle of the beam indication, which should not be used to limit the scope of the present application. For example, the substantial definition of the first state may change with the second or third state or fourth state, indicating that an uplink transmission is transmitted with the second beam of the two beams; or indicating an uplink transmission is transmitted with both of the two beams in the TDM manner, wherein the first repetition of the uplink transmission is transmitted with the first beam of the two beams; or indicating an uplink transmission is transmitted with both of the two beams in the TDM manner, wherein the first repetition of the uplink resource is transmitted with the first beam of the two beams.

In addition, persons skilled in the art should understand that the present application can also be applied to any scenario wherein multiple beams are configured or predefined but only part of them can be used for transmission, and the beam indication can be specifically designed in view of the number of the multiple beams and the beam(s) to be used for transmission.

After receiving the beam indication, the UE will determine the joint or UL common beam(s) used for an uplink transmission. As shown in FIG. 2, the UE will transmit the uplink transmission in step 206. Accordingly, the network side, e.g., the BS 101 as shown in FIG. 1 will receive the uplink transmission in step 205. In the case that the beam indication indicates only one joint or UL common TCI state, the remote side, e.g., the UE 103 as shown in FIG. 1 will transmit the uplink transmission according to the beam indication. Accordingly, the network side, e.g., the BS 101 as shown in FIG. 1 will receive the uplink transmission according to the beam indication. In the case that the beam indication indicates more than one joint or UL common TCI state, the remote side, e.g., the UE 103 as shown in FIG. 1 will transmit the uplink transmission according to the beam indication and a beam mapping configured for the uplink transmission. Accordingly, the network side, e.g., the BS 101 as shown in FIG. 1 will receive the uplink transmission according to the beam indication and the beam mapping pattern.

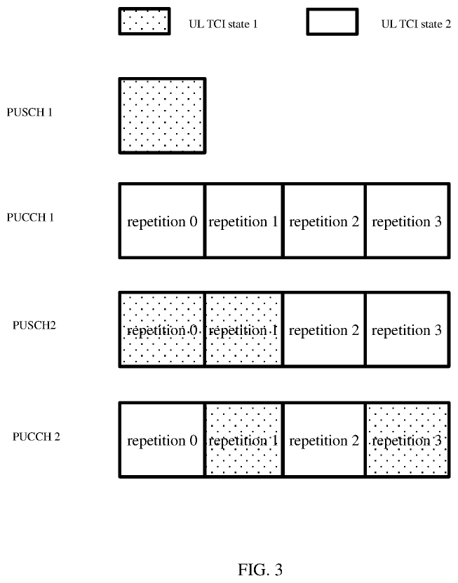

FIG. 3 illustrates a schematic diagram of beam determination for uplink transmission in the case of two joint or UL common beams being indicated to a UE according to some embodiments of the present application.

As shown in FIG. 3, it is assumed that two UL common beams, which are represented respectively by UL TCI state 1 and UL TCI state 2 are indicated to the remote side by DCI in a PDCCH, wherein the first UL common beam is represented by UL TCI state 1 and the second UL common beam is represented by UL TCI state 2. Besides, for a first uplink transmission with one repetition, i.e., PUSCH 1 which is scheduled by DCI in a PDCCH, the beam indication for PUSCH 1 is in the scheduling DCI. It is assumed that the beam indication of PUSCH 1 is indicated as “00.” For a second uplink transmission with four repetitions, i.e., PUCCH 1, the beam indication of PUCCH 1 is configured by a RRC signaling. It is assumed that the beam indication of PUCCH 1 is indicated as “01.” For a third uplink transmission with four repetitions, i.e., PUSCH 2, which is a configured grant Type 2 PUSCH, the beam indication for PUSCH 2 is configured in the configured grant configuration. It is assumed the beam indication for PUSCH 2 is indicated as “10.” For a fourth uplink transmission with four repetitions, i.e., PUCCH 2, the beam indication of PUCCH 2 is also configured by a RRC signaling. It is assumed that the beam indication of PUCCH 2 is indicated as “11.” Besides, a sequential mapping pattern is configured by a RRC signaling for PUSCH transmission with more than one repetition, and a cyclical mapping pattern is configured for PUCCH transmission with more than one repetition.

It is assumed that the states of the beam indication for each above uplink transmission is designed as above illustrated 4 exemplary states, wherein “00” is the first state indicating that all repetition(s) of the uplink transmission is transmitted according to the first joint or UL common TCI state of the plurality of joint or UL common TCI states; “01” is the second state indicating that all the repetition(s) of the uplink transmission is transmitted according to the second joint or UL common TCI state of the plurality of joint or UL common TCI states; “10” is the third state indicating that all the repetitions of the uplink transmission are transmitted according to the plurality of joint or UL common TCI states wherein the first repetition of the uplink transmission is transmitted according to the first joint or UL common TCI state of plurality of joint or UL common TCI states; and “11” is the fourth state indicating that all the repetitions of the uplink transmission are transmitted according to the plurality of joint or UL common TCI states wherein the first repetition of the uplink transmission is transmitted according to the second joint or UL common TCI state of plurality of joint or UL common TCI states. Accordingly, the beam for PUSCH 1 is UL TCI state 1 according to the first state of the beam indication, and the beam for all repetition of PUCCH 1 is UL TCI state 2 according to the second state of the beam indication. The first repetition and second repetition of PUSCH 2 is transmitted by UL TCI state 1 and the third repetition and fourth repetition of PUSCH 2 is transmitted by UL TCI state 2 according to the third state of the beam indication because a sequential mapping pattern is configured for PUSCH transmission. While the first repetition and third repetition of PUCCH 2 is transmitted by UL TCI state 2 and the second repetition and fourth repetition of PUCCH 2 is transmitted by UL TCI state 1 according to the fourth state of the beam indication because a cyclical mapping pattern is configured for PUCCH transmission.

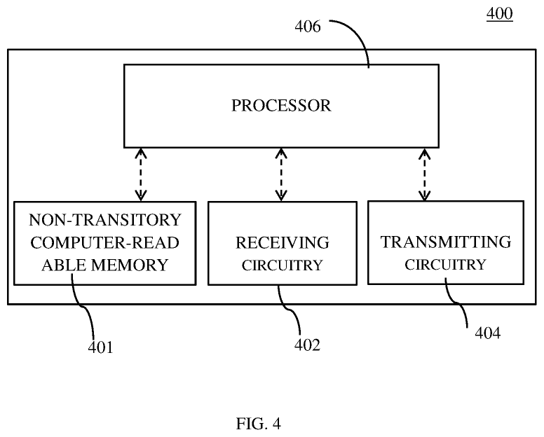

In addition, embodiments of the present application also propose an apparatus for uplink transmission. For example, FIG. 4 illustrates a block diagram of an apparatus 400 for uplink transmission according to some embodiments of the present application.

As shown in FIG. 4, the apparatus 400 may include at least one non-transitory computer-readable medium 401, at least one receiving circuitry 402, at least one transmitting circuitry 404, and at least one processor 406 coupled to the non-transitory computer-readable medium 401, the receiving circuitry 402 and the transmitting circuitry 404. The apparatus 400 may be a network side apparatus (e.g., a BS) configured to perform a method illustrated in FIG. 2 and the like, or a remote unit (e.g., a UE) configured to perform a method illustrated in FIG. 2 or the like.

Although in this figure, elements such as the at least one processor 406, transmitting circuitry 404, and receiving circuitry 402 are described in the singular, the plural is contemplated unless a limitation to the singular is explicitly stated. In some embodiments of the present application, the receiving circuitry 402 and the transmitting circuitry 404 can be combined into a single device, such as a transceiver. In certain embodiments of the present application, the apparatus 400 may further include an input device, a memory, and/or other components.

For example, in some embodiments of the present application, the non-transitory computer-readable medium 401 may have stored thereon computer-executable instructions to cause a processor to implement the method with respect to the UE as described above. For example, the computer-executable instructions, when executed, cause the processor 406 interacting with receiving circuitry 402 and transmitting circuitry 404, so as to perform the steps with respect to the UE depicted in FIG. 2.

In some embodiments of the present application, the non-transitory computer-readable medium 401 may have stored thereon computer-executable instructions to cause a processor to implement the method with respect to the BS as described above. For example, the computer-executable instructions, when executed, cause the processor 406 interacting with receiving circuitry 402 and transmitting circuitry 404, so as to perform the steps with respect to the BS depicted in FIG. 2.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus including a processor and a memory. Computer programmable instructions for implementing a method stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

What is claimed is:

1. A user equipment (UE) for wireless communication, comprising:
at least one memory; and
at least one processor coupled with the at least one memory and configured to cause the UE to:
receive information indicating a plurality of joint or uplink common transmission configuration indication (TCI) states;
receive a beam indication indicating at least one joint or uplink common TCI state of the plurality of joint or uplink common TCI states to be used for an uplink transmission, a repetition number of the uplink transmission is equal to or larger than one; and
transmit the uplink transmission, including in a case that the beam indication indicates more than one joint or uplink common TCI state, to transmit the uplink transmission according to the beam indication.

2. The UE of claim 1, wherein in a case that the uplink transmission is a configured grant Type 1 physical uplink shared channel (PUSCH) transmission or is a physical uplink control channel (PUCCH) transmission, the at least one processor is configured to cause the UE to receive the beam indication in a radio resource control (RRC) signaling for configuring the uplink transmission.

3. The UE of claim 1, wherein in a case that the uplink transmission is a physical uplink shared channel (PUSCH) transmission scheduled or activated by downlink control information (DCI) in a physical downlink control channel (PDCCH), the at least one processor is configured to cause the UE to receive the beam indication in the DCI.

4. The UE of claim 1, wherein in a case that the uplink transmission is a physical uplink control channel (PUCCH) transmission, the at least one processor is configured to cause the UE to receive the beam indication in a medium access control (MAC) control element (CE) associated with the PUCCH transmission.

5. The UE of claim 1, wherein a first state of the beam indication indicates that repetitions of the uplink transmission are transmitted according to a first joint or uplink common TCI state of the plurality of joint or uplink common TCI states, and a second state of the beam indication indicates that the repetitions of the uplink transmission are transmitted according to a second joint or uplink common TCI state of the plurality of joint or uplink common TCI states.

6. The UE of claim 1, wherein in a case that the repetition number of the uplink transmission is larger than one, a third state of the beam indication indicates that repetitions of the uplink transmission are transmitted according to the plurality of joint or uplink common TCI states where a first repetition of the uplink transmission is transmitted according to a first joint or uplink common TCI state of the plurality of joint or uplink common TCI states.

7. The UE of claim 1, wherein in a case that the repetition number of the uplink transmission is larger than one, a fourth state of the beam indication indicates that repetitions of the uplink transmission are transmitted according to the plurality of joint or uplink common TCI states where a first repetition of the uplink transmission is transmitted according to a second joint or uplink common TCI state of the plurality of joint or uplink common TCI states.

8. A base station for wireless communication, comprising:
at least one memory; and
at least one processor coupled with the at least one memory and configured to cause the base station to:
transmit information indicating a plurality of joint or uplink common transmission configuration indication (TCI) states;
transmit a beam indication indicating at least one joint or uplink common TCI state of the plurality of joint or uplink common TCI states to be used for an uplink transmission, a repetition number of the uplink transmission is equal to or larger than one; and
receive the uplink transmission, including in a case that the beam indication indicates more than one joint or uplink common TCI state, to receive the uplink transmission according to the beam indication.

9. The base station of claim 8, wherein in a case that the uplink transmission is a configured grant Type 1 physical uplink shared channel (PUSCH) transmission or is a physical uplink control channel (PUCCH) transmission, the at least one processor is configured to cause the base station to transmit the beam indication in a radio resource control (RRC) signaling for configuring the uplink transmission.

10. The base station of claim 8, wherein in a case that the uplink transmission is a physical uplink shared channel (PUSCH) transmission scheduled or activated by downlink control information (DCI) in a physical downlink control channel (PDCCH), the at least one processor is configured to cause the base station to transmit the beam indication in the DCI.

11. The base station of claim 8, wherein in a case that the uplink transmission is a physical uplink control channel (PUCCH) transmission, the at least one processor is configured to cause the base station to transmit the beam indication in a medium access control (MAC) control element (CE) associated with the PUCCH transmission.

12. The base station of claim 8, wherein a first state of the beam indication indicates that repetitions of the uplink transmission are transmitted according to a first joint or uplink common TCI state of the plurality of joint or uplink common TCI states, and a second state of the beam indication indicates that the repetitions of the uplink transmission are transmitted according to a second joint or uplink common TCI state of the plurality of joint or uplink common TCI states.

13. The base station of claim 8, wherein in a case that the repetition number of the uplink transmission is larger than one, a third state of the beam indication indicates that repetitions of the uplink transmission are transmitted according to the plurality of joint or uplink common TCI states where a first repetition of the uplink transmission is transmitted according to a first joint or uplink common TCI state of the plurality of joint or uplink common TCI states.

14. The base station of claim 8, wherein in a case that the repetition number of the uplink transmission is larger than one, a fourth state of the beam indication indicates that repetitions of the uplink transmission are transmitted according to the plurality of joint or uplink common TCI states, and a first repetition of the uplink transmission is transmitted according to a second joint or uplink common TCI state of the plurality of joint or uplink common TCI states.

15. (canceled)

16. A processor for wireless communication, comprising:
at least one controller coupled with at least one memory and configured to cause the processor to:
receive information indicating a plurality of joint or uplink common transmission configuration indication (TCI) states;
receive a beam indication indicating at least one joint or uplink common TCI state of the plurality of joint or uplink common TCI states to be used for an uplink transmission, a repetition number of the uplink transmission is equal to or larger than one; and
transmit the uplink transmission, including in a case that the beam indication indicates more than one joint or uplink common TCI state, to transmit the uplink transmission according to the beam indication.

17. The processor of claim 16, wherein in a case that the uplink transmission is a configured grant Type 1 physical uplink shared channel (PUSCH) transmission or is a physical uplink control channel (PUCCH) transmission, the at least one controller is configured to cause the processor to receive the beam indication in a radio resource control (RRC) signaling for configuring the uplink transmission.

18. The processor of claim 16, wherein in a case that the uplink transmission is a physical uplink shared channel (PUSCH) transmission scheduled or activated by downlink control information (DCI) in a physical downlink control channel (PDCCH), the at least one controller is configured to cause the processor to receive the beam indication in the DCI.

19. The processor of claim 16, wherein in a case that the uplink transmission is a physical uplink control channel (PUCCH) transmission, the at least one controller is configured to cause the processor to receive the beam indication in a medium access control (MAC) control element (CE) associated with the PUCCH transmission.

20. The processor of claim 16, wherein a first state of the beam indication indicates that repetitions of the uplink transmission are transmitted according to a first joint or uplink common TCI state of the plurality of joint or uplink common TCI states, and a second state of the beam indication indicates that the repetitions of the uplink transmission are transmitted according to a second joint or uplink common TCI state of the plurality of joint or uplink common TCI states.

21. The processor of claim 16, wherein in a case that the repetition number of the uplink transmission is larger than one, a third state of the beam indication indicates that repetitions of the uplink transmission are transmitted according to the plurality of joint or uplink common TCI states where a first repetition of the uplink transmission is transmitted according to a first joint or uplink common TCI state of the plurality of joint or uplink common TCI states.
